(19) United States
(12) Patent Application Publication
(10) Pub. No.: US 2010/0136968 A1
(43) Pub. Date: Jun. 3, 2010

(54) METHOD AND APPARATUS FOR QUICK NETWORK SEARCH IN MOBILE COMMUNICATION DEVICES

(75) Inventor: Prateek SRIVASTAVA, Bangalore (IN)

Correspondence Address: ONDA TECHNO Intl. Patent Attys., 12-1 Omiya-cho 2-chome, Gifu City, 500-8731, JP

(73) Assignee: FREESCALE SEMICONDUCTOR, INC., Austin, TX (US)

(21) Appl. No.: 12/503,062

(22) Filed: Jul. 14, 2009

(30) Foreign Application Priority Data
Dec. 3, 2008 (IN) 2739/DEL/2008

(51) Int. Cl. H04W 4/00; H04M 1/00

(52) U.S. Cl. 455/434; 455/550.1

(57) ABSTRACT

A mobile communication device connects to a mobile network identified from various mobile networks operating in a geographical area. Signal frequencies supported by the mobile communication device are scanned to identify a set of signal frequencies associated with the mobile networks. A set of network IDs associated with the mobile networks is determined by synchronizing with each signal frequency of the set of signal frequencies. The network IDs and associated signal frequencies are stored. Thereafter, the stored signal frequencies are scanned to identify a second set of network IDs. A network ID is selected from the second set of network IDs to connect to the mobile network.

### BACKGROUND OF THE INVENTION

The present invention relates generally to mobile communication devices, and more specifically, to power saving techniques for mobile communication devices.

Mobile communication devices need to connect to a mobile network to exchange information with other devices such as other mobile communication devices, web devices, and the like. Mobile networks have various base stations that operate over one or more signal frequencies. In order to connect to the mobile network, a mobile communication device connects to the base station in a particular geographical area. This geographical area may include base stations of various other mobile networks. Therefore, to connect to a particular mobile network, the mobile communication device needs to search for the mobile networks operating in the geographical area and then select the desired mobile network to exchange information.

The one or more signal frequencies supported by the mobile communication device are scanned to identify the base stations of the mobile networks operational in the geographical area. Thereafter, the mobile communication device synchronizes with the signal frequency of each of the identified mobile networks to obtain system information associated with each of the identified mobile networks. Further, the system information is decoded to determine network identifiers (IDs) associated with the signal frequencies having the maximum signal strength for each of the identified mobile networks. Subsequently, a mobile network is selected from the identified mobile networks by selecting a network ID from the identified network IDs.

However, the mobile communication device may need to re-search for the mobile networks for various reasons, for example, the mobile communication device moving to another geographical area, the mobile communication device being powered on, and so forth. For every re-search, the mobile communication device re-scans the entire range of signal frequencies supported by the mobile communication device. Furthermore, after each re-scan, the mobile communication device needs to repeat the steps of synchronization for each of the identified signal frequencies to identify the system information. Re-scanning the entire range of signal frequencies supported by mobile communication device is time consuming process and consumes a lot of battery power. The larger the number of signal frequencies to be scanned, the more battery power consumed. Thus, it would be advantageous to have a mobile device that consumed less power when searching for mobile networks.

### BRIEF DESCRIPTION OF THE DRAWINGS

The following detailed description of the preferred embodiments of the present invention will be better understood when read in conjunction with the appended drawings. The present invention is illustrated by way of example, and not limited by the accompanying figures, in which like references indicate similar elements.

FIG. 1 is a flow chart illustrating a method for searching for a mobile network from one or more mobile networks in a mobile communication device, in accordance with an embodiment of the present invention;

FIG. 2 is a flow chart illustrating a method for searching for a mobile network from one or more mobile networks in a mobile communication device, in accordance with another embodiment of the present invention; and

FIG. 3 is a block diagram of a mobile communication device, in accordance with an embodiment of the present invention.

### DETAILED DESCRIPTION OF THE PRESENT INVENTION

The detailed description of the appended drawings is intended as a description of the currently preferred embodiments of the present invention, and is not intended to represent the only form in which the present invention may be practiced. It is to be understood that the same or equivalent functions may be accomplished by different embodiments that are intended to be encompassed within the spirit and scope of the present invention.

In an embodiment of the present invention, a method is provided for searching for a mobile network from one or more mobile networks in a mobile communication device. The mobile networks operate over one or more signal frequencies. The one or more signal frequencies supported by the mobile communication device are scanned to identify a set of mobile networks from the one or more mobile networks. The set of mobile networks operates over a set of signal frequencies. Thereafter, a first set of network identifiers (IDs) associated with the set of mobile networks is determined by synchronizing with the set of signal frequencies. The first set of network IDs and a first set of signal frequencies associated with the first set of network IDs are stored in a memory of the mobile communication device. A second set of network IDs is identified from the stored first set of network IDs by scanning the stored first set of signal frequencies. Scanning of the stored first set of signal frequencies is initiated on the basis of the mobile communication device moving from a first geographical area to a second geographical area. Subsequently, the mobile network is selected by selecting a network ID from the second set of network IDs.

In another embodiment of the present invention, a method is provided for searching for a mobile network from one or more mobile networks in a mobile communication device. The mobile networks operate over one or more signal frequencies. The one or more signal frequencies supported by the mobile communication device are scanned to identify a set of mobile networks from the one or more mobile networks. The set of mobile networks operate over a set of signal frequencies. Thereafter, a first set of network identifiers (IDs) associated with the set of mobile networks is determined by synchronizing with the set of signal frequencies. The first set of network IDs and a first set of signal frequencies associated with the first set of network IDs are stored in a memory of the mobile communication device. A second set of network IDs is identified from the stored first set of network IDs by scanning the stored first set of signal frequencies. Scanning of the stored first set of signal frequencies is initiated on the basis of the mobile communication device operating over a first predetermined time interval. Subsequently, the mobile network is selected by selecting a network ID from the second set of network IDs.

In yet another embodiment of the present invention, a mobile communication device is provided for searching for a mobile network from one or more mobile networks. The mobile networks operate over one or more signal frequencies. The mobile communication device includes a scanning module for scanning one or more signal frequencies supported by the mobile communication device, to identify a set of mobile networks operating over a set of signal frequencies. A first set of network IDs is associated with the set of mobile networks. A memory module of the mobile communication device stores the first set of network IDs and a first set of signal frequencies associated with the first set of network IDs. Further, a control module of the mobile communication device initiates the scanning of the stored first set of signal frequencies on the basis of a set of predefined criteria. The scanning module scans the stored first set of signal frequencies to identify a second set of signal frequencies. A second set of network IDs is associated with the second set of signal frequencies. The memory module is updated with the second set of network IDs and the second set of signal frequencies. Thereafter, the control module selects a mobile network by selecting a network ID from the second set of network IDs.

The embodiments of the present invention provide a method for searching for a mobile network from one or more mobile networks in a mobile communication device. During a re-scan, the mobile communication device performs scanning of the stored first set of signal frequencies on the basis of the predefined criteria, instead of scanning the one or more signal frequencies supported by the mobile communication device. This saves a considerable amount of time spent in searching for a mobile network, and also facilitates a quick scan for the mobile communication device. Furthermore, the mobile communication device stores a mapping of network IDs with the set of signal frequencies identified during the previous scan. Therefore, time spent in synchronizing with the set of signal frequencies during a re-scan is also saved. Moreover, the mobile communication device consumes less battery power for the quick scan of mobile networks, as compared to the conventional scan of the one or more signal frequencies supported by the mobile communication device.

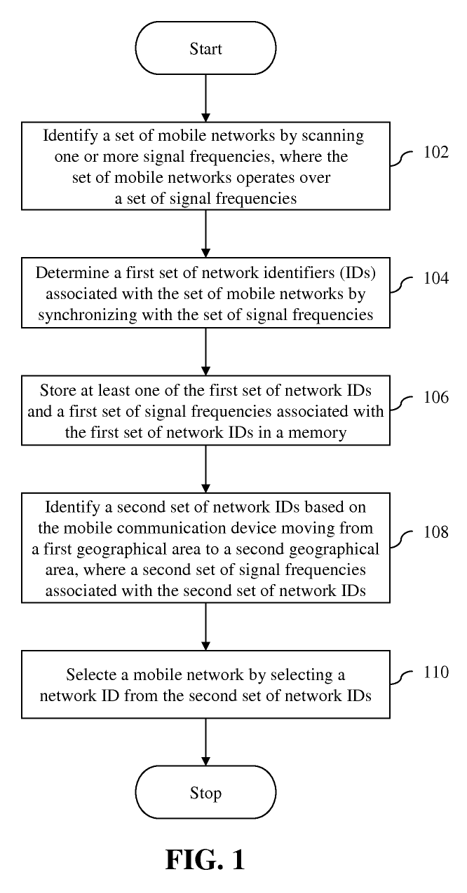

Referring now to FIG. 1, a flow chart illustrating a method for searching for a mobile network from one or more mobile networks in a mobile communication device is shown, in accordance with an embodiment of the present invention. Mobile networks have various base stations that operate over one or more signal frequencies. Each base station associated with a mobile network covers a geographical area. Further, the geographical area may include base stations of various other mobile networks operating in that geographical area. Therefore, to connect to a mobile network, the mobile communication device searches for the mobile networks operating in the geographical area. For example, a city may be divided into geographical area A and geographical area B. The mobile networks operating in the geographical areas A and B may be represented by mobile network P, mobile network Q, and mobile network R. The network identifiers (ID) associated with the mobile networks P, Q and R may be represented by exemplary symbols such as network_ID_P, network_ID_Q, and network_ID_R, respectively. Mobile networks P, Q and R may operate over one or more signal frequencies as shown in Table 1 below:

TABLE 1

| | | | Geo- |
|---|---|---|---|
| Mobile | | | graphi- |
| Net- | | Exemplary Signal | cal |
| work | Network ID | Frequencies | Area |
| P | network_ID_P | a) BS_P1 - (200 to 300) MHz | Geo- |
| | | b) BS_P2 - (300 to 350) MHz | graphi- |
| | | c) BS_P3 - (350 to 400) MHz | cal |
| Q | network_ID_Q | a) BS_Q1 - (1000 to 1100) MHz | Area A |
| | | b) BS_Q2 - (1100 to 1200) MHz | |
| R | network_ID_R | a) BS_R1 - (1800 to 1900) MHz | |
| | | b) BS_R2 - (1900 to 2000) MHz | |
| P | network_ID_P | a) BS_P4 - (300 to 400) MHz | Geo- |
| | | b) BS_P5 - (400 to 500) MHz | graphi- |
| Q | network_ID_Q | a) BS_Q3 - (1150 to 1250) MHz | cal |
| | | b) BS_Q4 - (1275 to 1350) MHz | Area B |
| | | c) BS_Q5 - (1350 to 1500) MHz | |
| R | network_ID_R | a) BS_R3 - (1850 to 1900) MHz | |
| | | b) BS_R3 - (2100 to 2200) MHz | |
| | | c) BS_R4 - (2250 to 2300) MHz | |
| | | d) BS_R5 - (2300 to 2450) MHz | |

At step 102, a set of mobile networks is identified from one or more mobile networks by scanning one or more signal frequencies supported by the mobile communication device. The set of mobile networks may operate over a set of signal frequencies. The scanning of the one or more signal frequencies may be initiated manually or automatically. According to the example, when the mobile communication device is in geographical area A, the one or more signal frequencies supported by the mobile communication device are scanned to identify a set of mobile networks. The identified set of mobile networks may be mobile networks P, Q and R; and the set of signal frequencies associated with them may be 225 MHz, 340 MHz, 360 MHz, 1050 MHz, 1125 MHz, and 1875 MHz.

At step 104, the mobile communication device determines a first set of network identifiers (IDs) associated with the set of mobile networks by synchronizing with each signal frequency of the set of signal frequencies. Further, a first set of signal frequencies is associated with the first set of network IDs. The first set of signal frequencies contains the signal frequencies having the maximum signal strength, associated with each of the set of mobile networks. The first set of signal frequencies is identified from the set of signal frequencies. Following the example given above, the first set of network IDs and the first set of signal frequencies may be as shown in Table 2 below:

TABLE 2

| Network ID | Exemplary Signal Frequency |
|---|---|
| network_ID_P | 340 MHz |
| network_ID_Q | 1125 MHz |
| network_ID_R | 1875 MHz |

At step 106, the identified first set of network IDs and the first set of signal frequencies are stored in a memory of the mobile communication device. In various embodiments of the present embodiment, Table 2 may be stored in the memory of the mobile communication device. Table 2 includes a mapping of the first set of network IDs with the first set of signal frequencies.

At step 108, a second set of network IDs is identified from the stored first set of network IDs by scanning the stored first set of signal frequencies. The second set of network IDs is associated with a second set of signal frequencies. According to the example given above, the signal frequencies 340 MHz, 1125 MHz and 1875 MHz, as shown in Table 2, are scanned to identify the second set of network IDs and the second set of signal frequencies as shown in Table 3 below:

TABLE 3

| Network ID | Exemplary Signal Frequency |
|---|---|
| network_ID_P | 340 MHz |
| network_ID_R | 1875 MHz |

In an embodiment of the present invention, the scanning of the stored first set of signal frequencies may be initiated when the user of the mobile communication device moves from a first geographical area to a second geographical area. In the example above, the scanning may be initiated when the user of the mobile communication device moves from geographical area A to geographical area B. It may be apparent to any person skilled in the art that the scanning may be initiated after a predefined number of movements of the mobile communication device from one geographical area to another.

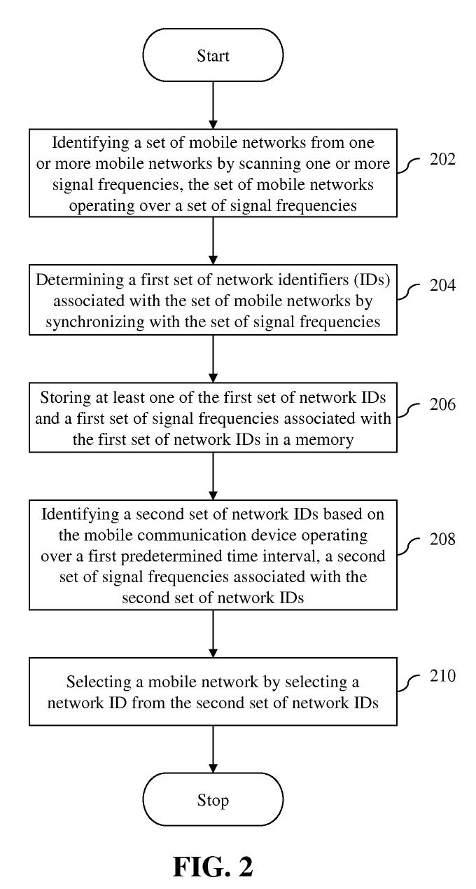

In another embodiment of the present invention, the scanning of the stored first set of signal frequencies may be initiated when the mobile communication device operates over a first predetermined time interval, which has been explained further in detail in conjunction with FIG. 2.

In yet another embodiment of the present invention, the scanning of the stored first set of signal frequencies may be initiated when the mobile communication device is disconnected from a previously selected mobile network. The scanning of the stored first set of signal frequencies may also be initiated when the mobile communication device is powered on. In various embodiments of the present invention, the scanning of the stored first set of signal frequencies may be initiated by the user by using an input module.

It should be noted that the scanning of the stored first set of signal frequencies is initiated to re-search for a mobile network in the mobile communication device.

At step 110, a mobile network is selected by selecting the corresponding network ID from the second set of network IDs. The network ID may be selected automatically or manually by a user.

In an embodiment of the present invention, at least one of the second set of network IDs, the second set of signal frequencies, the first set of network IDs, and the first set of signal frequencies is displayed to the user on a display module of the mobile communication device. Thereafter, a network ID is manually selected by a user from the displayed second set of network IDs to select the corresponding mobile network.

In various embodiments of the present invention, if no signal frequency is identified after the scanning of the stored first set of signal frequencies, then the process may be repeated from step 102, i.e., the one or more signal frequencies supported by the mobile communication device may be re-scanned. Further, scanning of the one or more signal frequencies may be periodically initiated after a second predetermined time interval. Scanning of the one or more signal frequency may also be initiated when the mobile communication device moves to another geographical area. Subsequently, the memory of the mobile communication device is updated with the newly identified first set of signal frequencies.

Referring now to FIG. 2, a flow chart illustrating a method for searching for a mobile network from one or more mobile networks in a mobile communication device is shown, in accordance with another embodiment of the present invention. At step 202, a set of mobile networks is identified from one or more mobile networks by scanning one or more signal frequencies supported by the mobile communication device. The set of mobile networks may operate over a set of signal frequencies.

At step 204, the mobile communication device determines a first set of network identifiers (IDs) associated with the set of mobile networks by synchronizing with each of the set of signal frequencies. The first set of network IDs is associated with a first set of signal frequencies.

At step 206, the identified first set of network IDs and the first set of signal frequencies are stored in a memory of the mobile communication device. At step 208, a second set of network IDs is identified from the stored first set of network IDs by scanning the stored first set of signal frequencies. The second set of network IDs is associated with a second set of signal frequencies. Steps 202, 204 and 206 correspond to steps 102, 104 and 106, respectively, as explained in conjunction with FIG. 1.

In an embodiment of the present invention, the scanning of the stored first set of signal frequencies may be initiated when the mobile communication device operates over a first predetermined time interval. The first predetermined time interval may vary based on the communication standard in which the mobile communication device operates. For example, the first predetermined time interval may be a multiple of 6 minutes for a mobile communication device that operates according to the 3GPP communication standard. After every 6 minutes, the stored first set of signal frequencies may be scanned to identify the second set of signal frequencies.

In another embodiment of the present invention, scanning of the stored first set of signal frequencies is initiated based on other conditions, for example, the mobile communication device moving from a first geographical area to a second geographical area, the mobile communication device being powered on, and the like, which have been explained in detail in conjunction with FIG. 1.

In various embodiments of the present invention, the scanning of the stored first set of signal frequencies may be initiated when a new subscriber identity module (SIM) card of a mobile network is inserted into the mobile communication device.

In another embodiment of the present invention, the scanning of the stored first set of signal frequencies may be initiated, when the previously selected mobile network denies the request for connection during roaming.

At step 210, a mobile network is selected by selecting the corresponding network ID from the second set of network IDs. The network ID may be selected automatically or manually by a user. Step 210 corresponds to step 110, as explained in conjunction with FIG. 1.

In an embodiment of the present invention, at least one of the second set of network IDs, the second set of signal frequencies, the first set of network IDs, and the first set of signal frequencies is displayed to the user on a display module of the mobile communication device. Thereafter, a network ID is manually selected by a user from the displayed second set of network IDs to select the corresponding mobile network.

In various embodiments of the present invention, if the scanning of the stored first set of signal frequencies does not identify any signal frequency, then the process may be repeated from step 202, i.e., the one or more signal frequencies supported by the mobile communication device are re-scanned. Further, scanning of the one or more signal frequencies may be periodically initiated after a second predetermined time interval. Scanning of the one or more signal frequency may also be initiated when the mobile communication device moves to another geographical area. Subsequently, the memory of the mobile communication device is updated with the newly identified first set of signal frequencies.

In various embodiments of the present invention, the mobile communication device may operate according to at least one of Universal Mobile Telecommunications System (UMTS), Global System for Mobile communications (GSM), Code Division Multiple Access (CDMA), High Speed Downlink Packet Access (HSDPA), Evolution-Data Optimized (EVDO), Long Term Evolution (LTE), and Worldwide Interoperability for Microwave Access (WiMAX) standards.

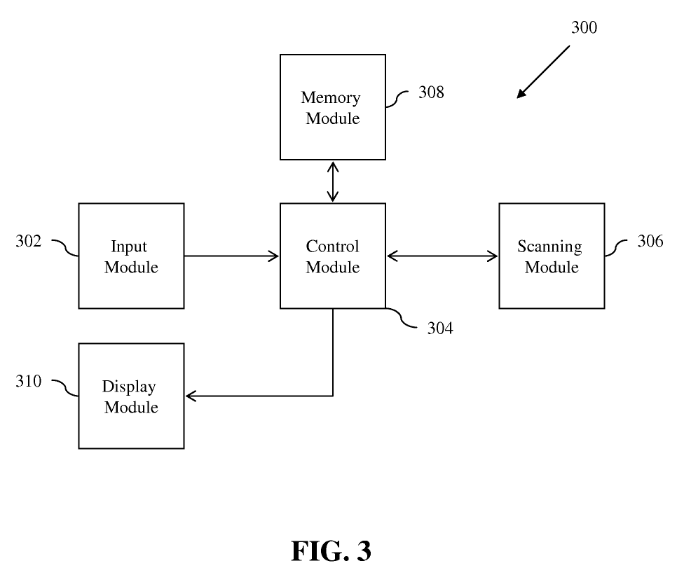

Referring now to FIG. 3, a block diagram illustrating a mobile communication device 300 is shown, in accordance with an embodiment of the present invention. The mobile communication device 300 includes an input module 302, a control module 304, a scanning module 306, a memory module 308, and a display module 310.

In order to connect to a mobile network in a geographical area, the mobile communication device 300 searches for the mobile network from one or more mobile networks operating in a geographical area. The one or more mobile networks operate over one or more signal frequencies.

The scanning module 306 scans one or more signal frequencies supported by the mobile communication device 300 to identify a set of mobile networks from the one or more mobile networks. The set of mobile networks may operate over a set of signal frequencies. According to the example given earlier, the mobile communication device 300 scans the one or more signal frequencies to identify a set of signal frequencies associated with mobile networks P, Q and R operating in geographical area A. The set of signal frequencies may be 225 MHz, 340 MHz, 360 MHz, 1050 MHz, 1125 MHz, and 1875 MHz. Thereafter, the scanning module 306 determines a first set of network IDs associated with each mobile network of the set of mobile networks by synchronizing with each signal frequency of the set of signal frequencies. The first set of network IDs is associated with a first set of signal frequencies from the set of signal frequencies. The first set of signal frequencies contains signal frequencies with the maximum signal strength associated with each mobile network of the set of the mobile networks. The exemplary first set of network IDs and first set of signal frequencies have been shown earlier in Table 2.

The memory module 308 stores the first set of network IDs and the first set of signal frequencies. In various embodiments of the present embodiment, Table 2 may be stored in the memory of the mobile communication device. Table 2 includes a mapping of the first set of network IDs with the first set of signal frequencies.

Thereafter, the control module 304 initiates scanning of the stored first set of signal frequencies to identify a second set of network IDs from the first set of network IDs. The second set of network IDs is associated with a second set of signal frequencies. In an embodiment of the present invention, the control module 304 retrieves the stored first set of network IDs and the stored first set of signal frequencies from the memory module 308 and provides this information to the scanning module 306. In another embodiment of the present invention, the scanning module 306 retrieves the stored first set of network IDs and the stored first set of signal frequencies directly from the memory module 308. According to the example given earlier, the second set of network IDs and the second set of signal frequencies are shown in Table 3, as explained earlier in conjunction with FIGS. 1 and 2. Further, in various embodiments of the present invention, the control module 304 initiates scanning of the stored first set of signal frequencies on the basis of a set of predefined criteria.

In various embodiments of the present invention, the set of predefined criteria may include at least one of the mobile communication device 300 moving from a first geographical area to a second geographical area, the mobile communication device 300 being disconnected from the selected mobile network, the mobile communication device 300 operating over a first predetermined time interval, the mobile communication device 300 being powered on, a new SIM card being inserted in the mobile communication device 300, and the selected mobile network denying connection during roaming. The initiation of scanning based on the set of predefined criteria has been explained earlier in conjunction with FIGS. 1 and 2.

In an embodiment of the present invention, the input module 302 enables a user of the mobile communication device 300 to initiate the scanning of the stored first set of signal frequencies.

The display module 310 displays the second set of network IDs and the second set of signal frequencies to the user of the mobile communication device 300. Thereafter, the user may select a mobile network by selecting a network ID from the displayed network IDs using the input module 302.

In various embodiments of the present invention, the control module 304 may initiate scanning of the one or more signal frequencies when scanning of the first set of signal frequencies does not identify any signal frequency. In another embodiment of the present invention, the control module 304 may periodically initiate scanning of the one or more signal frequencies after a second predetermined time interval. In yet another embodiment of the present invention, the control module 304 may initiate scanning of the one or more signal frequencies when the mobile communication device moves to another geographical area. Subsequently, the memory module 308, updates the memory of the mobile communication device with the newly identified first set of signal frequencies.

While various embodiments of the present invention have been illustrated and described, it will be clear that the present invention is not limited to these embodiments only. Numerous modifications, changes, variations, substitutions, and equivalents will be apparent to those skilled in the art, without departing from the spirit and scope of the present invention, as described in the claims.

1. A method for searching for a mobile network from one or more mobile networks by a mobile communication device, each of the one or more mobile networks operating over one or more signal frequencies, comprising:
identifying a set of mobile networks from the one or more mobile networks by scanning the one or more signal frequencies, the set of mobile networks operating over a set of signal frequencies;
determining a first set of network identifiers (IDs) associated with the set of mobile networks by synchronizing with the set of signal frequencies;
storing at least one of the first set of network IDs and a first set of signal frequencies associated with the first set of network IDs in a memory of the mobile communication device;
identifying a second set of network IDs from the stored first set of network IDs by scanning the stored first set of signal frequencies based on the mobile communication device moving from a first geographical area to a second geographical area, wherein a second set of signal frequencies is associated with the second set of network IDs; and
selecting the mobile network by selecting a network ID from the second set of network IDs.

2. The method of claim 1, further comprising initiating the scanning of the stored first set of signal frequencies based on the mobile communication device operating over a first predetermined time interval.

3. The method of claim 1, further comprising initiating the scanning of the stored first set of signal frequencies based on the mobile communication device being powered on.

4. The method of claim 1, further comprising initiating the scanning of the stored first set of signal frequencies based on the mobile communication device being disconnected from the selected mobile network.

5. The method of claim 1, further comprising initiating the scanning of the stored first set of signal frequencies using an input module of the mobile communication device.

6. The method of claim 1, further comprising initiating the scanning of the one or more signal frequencies based on at least one of a second predetermined time interval, the second set of signal frequencies not being identified from the scanning of the stored first set of signal frequencies, and the mobile communication device moving from the first geographical area to the second geographical area.

7. The method of claim 1, further comprising displaying at least one of the first set of network IDs, the second set of network IDs, the first set of signal frequencies, and the second set of signal frequencies on a display module of the mobile communication device.

8. A method for searching for a mobile network from one or more mobile networks by a mobile communication device, each of the one or more mobile networks operating over one or more signal frequencies, comprising:
identifying a set of mobile networks from the one or more mobile networks by scanning the one or more signal frequencies, the set of mobile networks operating over a set of signal frequencies;
determining a first set of network identifiers (IDs) associated with the set of mobile networks by synchronizing with the set of signal frequencies;
storing at least one of the first set of network IDs and a first set of signal frequencies associated with the at least one of the first set of network IDs in a memory of the mobile communication device;
identifying a second set of network IDs from the stored first set of network IDs by scanning the stored first set of signal frequencies based on the mobile communication device operating over a first predetermined time interval, wherein a second set of signal frequencies is associated with the second set of network IDs; and
selecting the mobile network by selecting a network ID from the second set of network IDs.

9. The method of claim 8, further comprising initiating the scanning of the stored first set of signal frequencies based on the mobile communication device moving from a first geographical area to a second geographical area.

10. The method of claim 8, further comprising initiating the scanning of the stored first set of signal frequencies based on the mobile communication device being powered on.

11. The method of claim 8, further comprising initiating the scanning of the stored first set of signal frequencies based on the mobile communication device being disconnected from the selected mobile network.

12. The method of claim 8, further comprising initiating the scanning of the stored first set of signal frequencies using an input module of the mobile communication device.

13. The method of claim 8, further comprising initiating the scanning of the one or more signal frequencies based on at least one of a second predetermined time interval, the second set of signal frequencies not being identified from the scanning of the stored first set of signal frequencies, and the mobile communication device moving from the first geographical area to the second geographical area.

14. The method of claim 8, further comprising displaying at least one of the first set of network IDs, the second set of network IDs, the first set of signal frequencies, and the second set of signal frequencies on a display module of the mobile communication device.

15. A mobile communication device capable of searching for a mobile network from one or more mobile networks, each of the one or more mobile networks operating over one or more signal frequencies, comprising:
a scanning module for scanning the one or more signal frequencies to identify a set of mobile networks therefrom, the set of mobile networks operating over a set of signal frequencies, wherein a first set of network identifiers (IDs) is associated with the set of mobile networks, and scanning a first set of signal frequencies associated with the first set of network IDs to identify a second set of network IDs, wherein a second set of signal frequencies is associated with the second set of network IDs;
a memory module for storing at least one of the first set of signal frequencies, the second set of signal frequencies, the first set of network IDs, and the second set of network IDs; and
a control module for initiating scanning of at least one of the one or more signal frequencies and the stored first set of signal frequencies based on a set of predefined criteria, and selecting a mobile network by selecting a network ID from the second set of network IDs.

16. The mobile communication device of claim 15, wherein the set of predefined criteria comprises the mobile communication device moving from a first geographical area to a second geographical area.

17. The mobile communication device of claim 15, wherein the set of predefined criteria further comprises at least one of the mobile communication device operating over a first predetermined time interval, the mobile communication device being powered on, and the mobile communication device being disconnected from the selected mobile network.

18. The mobile communication device of claim 15, further comprising an input module for initiating the scanning of the stored first set of signal frequencies.

19. The mobile communication device of claim 15, wherein the control module is further configured for initiating the scanning of the one or more signal frequencies based on at least one of a second predetermined time interval, the second set of signal frequencies not being identified from the scanning of the stored first set of signal frequencies, and the mobile communication device moving from the first geographical area to the second geographical area.

20. The mobile communication device of claim 15, further comprising a display module configured for displaying at least one of the first set of network IDs, the second set of network IDs, the first set of signal frequencies, and the second set of signal frequencies.
